(19) United States
(12) Patent Application Publication
(10) Pub. No.: US 2002/0171897 A1
(43) Pub. Date: Nov. 21, 2002

(54) System and method for a high-speed, customizible subscriber network using optical wireless links

(76) Inventors: Kyuman Cho, Seoul (KR); Young-Wan Choi, Seoul (KR)

Correspondence Address: FLESHNER & KIM LLP, POST OFFICE BOX 221200, CHANTILLY, VA, 20153-1200, US

(21) Appl. No.: 09/908,728

(22) Filed: Jul. 20, 2001

Related U.S. Application Data
(60) Provisional application No. 60/290,685, filed on May 15, 2001.

(51) Int. Cl. H04J 14/02; H04B 10/00

(52) U.S. Cl. 359/172; 359/125

(57) ABSTRACT

A plurality of short-range optical wireless links are coupled together to form a high-speed, customized subscriber network. Each of the plurality of short-range optical wireless links has a short-range optical transmitter and a short-range optical receiver. These devices are separated by a distance over which fading of received optical power caused by atmospheric turbulence can be neglected. In an embodiment, the subscriber network includes at least one medium-range optical wireless link for communicating over a distance up to 500 meters. In an embodiment, the subscriber network includes at least one long-range optical wireless link for communicating over a distance greater than 500 meters.

### CROSS-REFERENCE TO RELATED APPLICATIONS

This application claims the benefit of U.S. Provisional Patent Application Ser. No. 60/290,685, filed May 15, 2001, which is incorporated in its entirety herein by reference.

### FIELD OF THE INVENTION

The present invention relates to communications. More particularly, it relates to high-speed optical wireless subscriber networking technology.

### BACKGROUND OF THE INVENTION

High-speed subscriber service is in increasing demand. A fiber-optic backbone using ultra-fast opto-electronics and photonics technologies and dense wavelength division multiplexing (DWDM) techniques can handle enormously high data rate data streams. Data rates in excess of one terabit per second are possible. The development of L-band erbium-doped fiber amplifiers (EDFAs) and other optical fiber amplifiers ensures that sufficient fiber-optic backbone capability will be available to meet the increasing demand for high-speed subscriber service. However, in order to provide high-speed subscriber service, for example, to commercial buildings, to office buildings, to apartment buildings, to residential homes, etc., economical means for connecting them to the high-speed fiber-optic backbone are required, i.e., the so called “last mile” connection.

High-speed subscriber services can be provided using fiber-optic cables connected to the fiber-optic backbone. Installing a fiber-optic cable, however, is not a viable option for most subscribers because it requires expensive, time-consuming construction work. Other known means for providing subscriber networks, for example, cable MODEMs, x-DSL, and power MODEMs provide only limited-speed data services because communication speeds for these wired schemes decrease rapidly with distance.

A next generation wireless system, the IMT2000 system, will presumably be able to provide a two megabits per second data service to a stationary subscriber, however, two megabits per second is not sufficient to support multimedia services such as, for example, video-on-demand, High Definition TV, internet conferencing, et cetera. Moreover, it is unclear how many subscribers in a given micro- or pico-cell area can be simultaneously supported by this system because of the limited communication bandwidth assigned to this system. Radio frequency communication links are intrinsically limited in their data rate because of the relatively low carrier frequencies involved compared to optical carriers. While the use of microwaves for networking buildings in an urban area, for example, in a local-to-multipoint distribution service (LMDS), is possible, the cost of microwave components are too expensive to make a LMDS link a viable option for most prospective subscribers.

Efforts to use long-range optical wireless devices to provide high-speed data access to commercial buildings in a business district of a city have been attempted. Long-range optical wireless devices can provide high-speed communications over long distances. In a long-range optical wireless communication link, the optical beam passes through the atmosphere. Because of atmospheric turbulence, however, the wave fronts of the optical beam of these devices are distorted. A distorted wave front results in fluctuations in received power that can result in a loss of data. Furthermore, the performance of these known long-range optical wireless devices is degraded by signal fading caused by other weather conditions. Schemes for reducing the fading caused atmospheric and/or other weather conditions have been proposed, but these schemes require expensive instrumentation. Thus, the known long-range optical wireless schemes appear to have limited applications.

What is needed is a method and system that can provide low cost, reliable, high-speed data links to subscribers.

### SUMMARY OF THE INVENTION

The present invention provides a system and method for configuring a high-speed, customizable subscriber network using optical wireless communication links. In an embodiment, a short-range optical transmitter is coupled to a first network, and a short-range optical receiver is coupled to a first subscriber's digital communication device. The first subscriber's digital communication device is not otherwise a part of the first network. Data is transmitted from the first network to the first subscriber's digital communication device via a first short-range optical link formed by the first short-range transmitter and the first short-range optical receiver. As used herein, short-range means the range over which received optical power fluctuations, caused by atmospheric turbulence and/or obscuration, are negligible. A length of a short-range optical wireless link according to the invention is typically in a range of up to 300 meters, wherein a maximum length depends on environmental and geographical conditions.

In an embodiment, subscribers in an urban area are linked together by two or more short-range optical wireless links coupled together using a repeater and/or a relay according to the invention. A repeater according to the invention typically comprises a pair of optical wireless devices (e.g., a receiver/transmitter pair) that have clock and data recovery functions. A relay according to the invention typically comprises a pair of optical wireless devices (e.g., a receiver/transmitter pair) that do not have clock and data recovery functions. Buildings in between subscribers can be used as a repeater and/or relay stations according to the invention. Data can be dropped and/or added at a repeater and/or relay station in order to provide high-speed data access to the repeater and/or relay station.

In an embodiment, a system according to the invention comprises subscriber zones. Subscriber zones (SZs) are one means for configuring a high-speed, customizable subscriber network according to the invention. A subscriber zone has a central subscriber zone node (SZN) where a high-speed communication backbone service is available. This backbone service can be, for example, a previously existing or a newly installed high-speed fiber-optic communications link or an optical wireless communications link that has access to a metro or long-haul backbone system. A subscriber zone can be partitioned into several sub-regions called sub-subscriber zones (SSZs). Each sub-subscriber zone has the sub-subscriber zone node (SSZN) where an extended backbone service from a subscriber zone node is available. In embodiments, short-range optical wireless links according to the invention are used for establishing an extended backbone link. In other embodiments, a medium-range optical wireless link, a fiber-optic link, or a conventional wire link is used to extend a backbone link. Several subscriber zones comprise a subscriber region.

In an embodiment, subscribers in each sub-subscriber zone share data services carried by an extended backbone link. In an embodiment, each subscriber link comprises a short-range optical wireless link. In another embodiment, a subscriber link can comprise a combination of a short-range optical wireless link according to the invention and a conventional high-speed wire link such as, for example, a coaxial cable or a fiber optic cable.

Subscriber networks according to the invention can be customized and/or configured using one or more networking topologies such as, for example, a ring, a star, a tree, a bus, and/or a mesh topology. Subscriber network parameters such as, for example, the number of subscriber zones and/or sub-subscriber zones in a subscriber region, the size and shape of each subscriber zone and/or sub-subscriber zone, and the data rate and/or bandwidth of each optical wireless link can be customized. Network parameters are selected, for example, according to environmental and/or geographical conditions, the number of subscribers requesting service in a particular area, and/or the data speeds requested by each individual subscriber. For example, in an embodiment in a city residential area, an extended backbone link can carry either OC-3 (155 Mbps) SONET/SDH or 100 Mbps Ethernet data to a specific sub-subscriber zone and a number of subscribers in the sub-subscriber zone can share the link. In another embodiment, for example in a business district in a city, extended backbones can carry either OC-3, OC-12, OC-48, or several channels of OC-48 links. These extended backbone services can then be distributed in several different ways according to the invention. For example, several small buildings may share OC-3 extended backbone service, or one large business building can possess an exclusive OC-12, OC-48 or 1 Gb/s Ethernet link. In this latter instance, the large business building can comprise a single sub-subscriber zone.

In an embodiment, the first subscriber's digital communication device is a computer. In another embodiment, the first subscriber's digital communication device comprises an audio and/or audiovisual device.

A feature of the invention allows the first short-range optical transmitter to form a beam of electromagnetic energy that is eye-safe. In an embodiment, the beam of electromagnetic energy is a collimated beam having a minimum nominal beam divergence of 1×10⁻³ radian. The first short-range optical transmitter forms a beam of electromagnetic energy having a footprint larger than a lens of the first short-range optical receiver. In an embodiment, the beam of electromagnetic energy has a nominal wavelength of 1.55×10⁻⁶ meters. In other embodiments, other wavelengths are used.

Another feature of the invention allows short-range optical wireless links according to the invention to provide wideband, robust, reliable, and inexpensive data links to various subscribers such as, for example, office buildings, apartment buildings, individual apartments, single-family houses, et cetera. In embodiments, optical devices according to the invention do not require special optical arrangements and/or special data processing equipment. In embodiments, receivers do not require large aperture collecting lenses. In embodiments, transmitters do not require high power laser signal beams. Moreover, in embodiments, optical devices such as receivers, transmitters, and transceivers can be constructed using low cost optical components and standard over-the-shelf optical communication components.

Still another feature of the invention allows optical devices such as receivers, transmitters and/or transceivers according to the invention to be integrated into small size units. These small size units can be mounted, for example, on the rooftops of buildings, inside or outside of windows, and/or on the outside walls of houses and buildings. Signal fading caused by mechanical vibrations of a transmitter/receiver pair of a short-range optical wireless link according to the invention can be neglected, as can tip and tilt motion caused by mechanical vibrations.

Further features and advantages of the present invention, as well as the structure and operation of various embodiments of the present invention, are described in detail below with reference to the accompanying drawings.

### BRIEF DESCRIPTION OF TIE DRAWINGS/FIGURES

The accompanying drawings, which are incorporated and form part of the specification, illustrate the present invention and, together with the description, further serve to explain the principles of the invention and to enable a person skilled in the pertinent art to make and use the invention.

In the drawings:

FIG.1 illustrates a networking of neighboring buildings with short-range optical wireless links according to an embodiment of the invention.

FIG.2 illustrates a configuration of links between two distant buildings according to an embodiment of the invention, which uses other buildings in between them as repeater stations.

FIG. 3 illustrates a system for configuring a subscriber region with subscriber zones according to an embodiment of the present invention.

FIG. 4 illustrates a system for configuring a subscriber zones with sub-subscriber zones according to an embodiment of the present invention.

FIG. 5A illustrates a ring subscriber zone node networking configuration according to an embodiment of the invention.

FIG. 5B illustrates a star subscriber zone node networking configuration according to an embodiment of the invention.

FIG. 5C illustrates a tree subscriber zone node networking configuration according to an embodiment of the invention.

FIG. 5D illustrates a bus subscriber zone node networking configuration according to an embodiment of the invention.

FIG. 6A illustrates a ring sub-subscriber zone node networking configuration according to an embodiment of the invention.

FIG. 6B illustrates a star sub-subscriber zone node networking configuration according to an embodiment of the invention.

FIG. 6C illustrates a tree sub-subscriber zone node networking configuration according to an embodiment of the invention.

FIG. 6D illustrates a bus sub-subscriber zone node networking configuration according to an embodiment of the invention.

FIGS. 7-9 illustrate additional networking configurations according to embodiments on the present invention.

FIG. 10 illustrates a block diagram of a transmitter according to an embodiment of the invention.

FIG. 11 illustrates a block diagram of a receiver according to an embodiment of the invention.

FIGS. 12A and 12B illustrate block diagrams of an exemplary transceiver according to an embodiment of the invention.

FIGS. 13A and 13B illustrate exemplary lenses used with embodiments of the invention.

FIG. 14 illustrates an n-channel data stream to an n-channel device according to an embodiment of the invention.

FIG. 15 illustrates an n-channel to an n-channel data stream device according to an embodiment of the invention.

FIG. 16 illustrates an exemplary multiplexing device for dropping and adding channels of data according to an embodiment of the invention.

FIG. 17 illustrates an exemplary coupler unit using an electrical power splitter according to an embodiment of the invention.

FIG. 18 illustrates an exemplary coupler unit using an optical power splitter according to an embodiment of the invention.

FIG. 19 illustrates an exemplary combiner unit according to an embodiment of the invention.

FIG. 20 is a flowchart illustrating the steps of a method for providing customizable subscriber access to a network according to an embodiment of the invention.

FIG. 21 is a flowchart illustrating the steps of a method for providing a subscriber customizable access to a network according to an embodiment of the invention.

### DETAILED DESCRIPTION OF THE INVENTION

### Overview

The present invention provides a system and method for configuring a high-speed, customizable subscriber network using optical wireless communication links. Subscriber networks according to the invention are customized and/or configured using one or more networking topologies such as, for example, a ring, a star, a tree, a bus, and/or a mesh topology. Subscriber network parameters such as, for example, the number of subscriber zones and/or sub-subscriber zones in a subscriber region, the size and shape of each subscriber zone and/or sub-subscriber zone, and the data rate and/or bandwidth of each optical wireless link are also customizable. Network parameters are selected, for example, according to environmental and/or geographical conditions, the number of subscribers requesting service in a particular area, and/or the data speeds and bandwidth requested by each individual subscriber.

A feature of the invention allows short-range optical wireless links according to the invention to provide wideband, robust, reliable, and inexpensive data links to various subscribers such as, for example, office buildings, apartment buildings, individual apartments, single-family houses, et cetera. This scheme is referred to herein as optical wireless to the subscriber. The performance of a short-range optical wireless link according to the invention is not degraded by atmospheric turbulences. Moreover, short-range optical wireless links according to the invention do not require a high transmission power in order to compensate for power loss due to rain, snow, and/or fog.

Another feature of the invention allows optical devices such as receivers, transmitters and/or transceivers according to the invention to be integrated into small size units. These small size units can be mounted, for example, on the rooftops of buildings, inside or outside of windows, and/or on the outside walls of houses and buildings. These small units can also be mounted on other type of structures such as, for example, docked ships at a port, a stationary aircraft, or on an electrical utility pole, or other similar stationary structures. These units can be used, for example, to interconnect campus type environments. These units can also provide interconnectivity both within and between archeologically or architecturally significant structures, where it can be impossible to provide wired or fiber interstructure.

Further features and advantages of the present invention, as well as the structure and operation of various embodiments of the present invention, are described in detail below with reference to the accompanying drawings.

The detailed description of the present invention that follows begins with a terminology subsection that defines terms used to describe the present invention. The terminology subsection is followed by a detailed description of various systems and devices of the invention. Finally, this section concludes by describing in detail method embodiments of the present invention.

### Terminology

The following terms are defined so that they may be used to describe embodiments of the present invention. As used herein:

“Short-range” means the range over which received optical power fluctuations caused by, for example, fading, atmospheric turbulence and/or obscuration are negligible and thus the performance of an optical wireless links is not degraded. The length of short-range optical wireless link according to the invention may vary from one region to the other. For example, the length of short-range optical wireless link according to the invention in a tropical region may be shorter than that for the temperate region. An example length of a short-range optical wireless link according to the invention is typically in a range of about 200 to 300 meters, wherein the length depends on environmental and/or geographical conditions. However, in some regions of the world, an example length of a short-range optical wireless link according to the invention may be about 100 meters, for example, in a region of occasional dense fog.

“Subscriber Region” means a region (e.g., an area or city) where many subscribers exist. Subscribers in a subscriber region are generally provided with customizable high-speed data services. A subscriber region may have optical fiber backbone infrastructures (such as but not limited to a metro ring) available to which subscribers can be connected. A part or all of the installed high-speed backbone infrastructures in a subscriber region, however, can comprise optical wireless links according to the invention. A subscriber region can be partitioned into several subscriber zones.

“Subscriber Zone” (SZ) means one of the partitioned zones of subscriber region. Subscribers in a SZ can be networked together using optical wireless links according to the invention. The subscribers in a SZ can be networked together using short-range optical wireless links according to the invention. A SZ may have an exclusive high-speed backbone node (such as but not limited to a metro ring node) through which direct access to the information highway is possible. Subscribers in a SZ can share data services from the same backbone. In one example not intended to limit the invention a SZ is any area surrounding a metro ring node.

A subscriber zone according to the invention is different from a cellular configuration used in wireless, radio frequency (RF) telecommunications. For example, hand-off of communication from a subscriber in one zone to another zone does not occur in a way that is required in cellular, RF wireless telecommunications. The cellular, RF wireless concept was developed to allow carrier frequency re-use in nearby, but not directly adjacent, cells. Carrier frequency re-use, however, is not an issue in optical wireless communications. Optical wireless links can use a signal carrier frequency (wavelength), or different carrier frequencies (wavelengths) in adjacent subscriber zones. Interference between optical wireless signals intended for different subscribers is avoided not by the shape and size of a subscriber zone but by pointing beams of electromagnetic energy from a particular transmitter to a particular receiver. Thus, a subscriber zone according to the invention does not have a fixed shape, and it can overlap with other subscriber zones.

“Subscriber zone node” (SZN) means a structure (such as but not limited to a building) having access to a high-speed communications backbone such as, for example, a business ring or a metro ring. Each SZ has its own SZN.

“Sub-subscriber zone” (SSZ) means two or more subscribers linked by a short-range optical wireless link. A subscriber zone is typically subdivided into sub-subscriber zones.

“Sub-subscriber zone node” (SSZN) means a structure (such as but not limited to a building) having access to a SZN through a high-speed link, referred to herein as an extended backbone link. An extended backbone link may comprise one or more short-range optical wireless links according to the invention. In an embodiment of the invention, a conventional high-speed wired or wireless communication link is used as an extended backbone link.

### Example System Embodiments of the Invention

In urban areas, many structures such as, for example, commercial buildings, school buildings, apartment complexes, town homes, houses, towers and/or bridges are located relatively close to one another. Therefore, adjacent structures in these areas can be linked together using optical wireless links to form a subscriber network according to the invention. If one of these structures, for example, a commercial building, has access to a high-speed communications backbone such as a business ring or a metro ring, other buildings in the area can have the same access through one or more optical wireless links according to the invention. A structure having access to a high-speed backbone is referred to herein as a subscriber zone node (SZN).

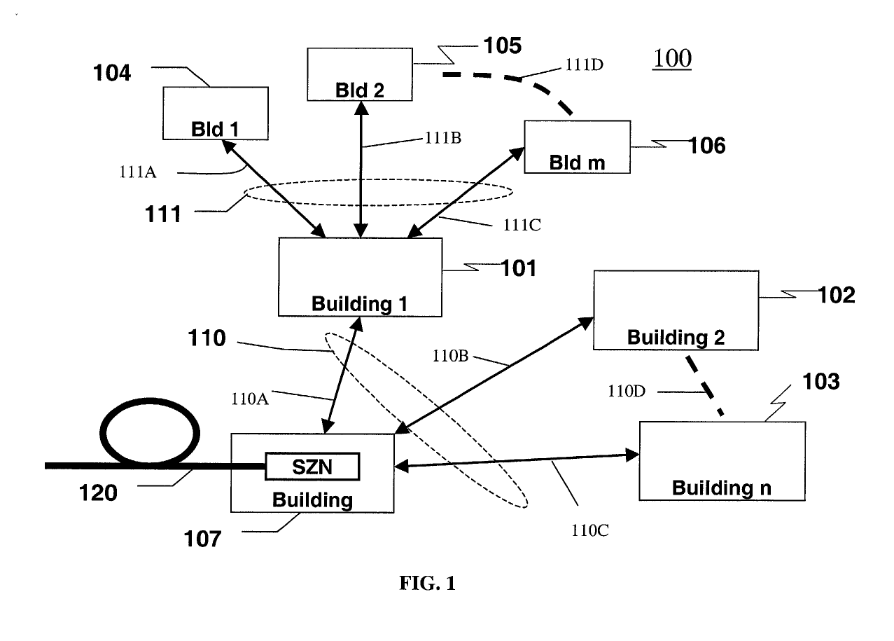

FIGS. 1-9 depict exemplary system embodiments or subscriber networks according to the invention. The subscriber networks shown in FIGS. 1-9 can be combined in order to form additional subscriber networks according to the invention. Thus, the networks of FIGS. 1-9 are illustrative, and not intended to limit the invention.

FIG. 1 illustrates a subscriber network 100 according to an embodiment of the invention. Subscriber network 100 comprises neighboring buildings 101, 102, 103, 104, 105, 106 and 107 coupled together using short-range optical wireless links 110 and 111 according to the invention. Networking topologies such as a ring, a star, a tree, a bus, a mesh, et cetera, or combination thereof, can be used for networking buildings 101-107. In addition, any data format and protocol can be carried by short-range links 110 and 111 at any data speed. For example, short-range optical wireless links 110 can carry any of OC-1, OC-3, OC-12, and OC-48 SONET/SDH data streams or 10 Mb/s, 100 Mb/s, and 1 Gb/s Ethernet data streams. In an embodiment, one or more short-range optical wireless links 110 and/or 111 can be replaced by any conventional high-speed wired and/or wireless communications link.

Building 107 is a SZN having direct access to a high-speed major backbone or information highway 120. As used herein, a high-speed major backbone typically has a transmission rate of at least 2.5 gigabits per second. Backbone 120 can be, for example, a fiber-optic link, an optical wireless link, or another type of wired or wireless communication link. Building 107 is coupled to building 101 by a short-range optical wireless link 110A. Building 107 is coupled to building 102 by a short-range optical wireless link 110B. Building 107 is also coupled to building 103 by a short-range optical wireless link 110C. An optional short-range optical wireless link 110D couples buildings 102 and 103 in order to provide a more robust network.

When a building, such as building 101, does not consume any or all of the data service supplied by optical wireless link 110A, other neighboring buildings 104, 105, 106 can share the data access using optical wireless links 111. Building 101 is coupled to building 104 by a short-range optical wireless link 111A. Building 101 is also coupled to buildings 105 and 106 by a short-range optical wireless link 111B and 111C, respectfully. An optional link 111D couples buildings 105 and 106 in order to provide a more robust network.

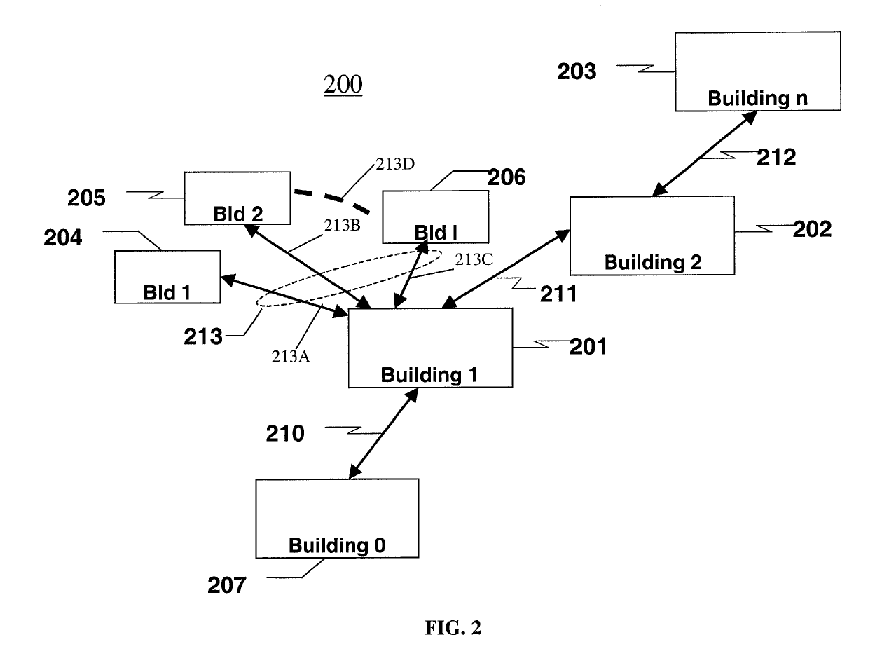

FIG. 2 illustrates a subscriber network 200 according to an embodiment of the invention. Subscriber network 200 comprises neighboring buildings 201, 202, 203, 204, 205, 206 and 207 coupled together using short-range optical wireless links according to the invention. Any networking topology such as a ring, a star, a bus, a tree, a mesh, et cetera, or combination thereof, can be used for configuring subscriber network 200. In an embodiment, one or more of the short-range optical wireless links 210, 211, 212, and/or 213 can be replaced by a conventional high-speed wired and/or wireless communications link. Any data formats and protocols can be carried by the short-range links shown in FIG. 2 at any data speed.

Network 200 illustrates how to extend a length of a short-range optical wireless link using one or more repeater stations. When two buildings 203 and 207 are far apart and cannot be linked together using a signal short-range optical wireless link, other buildings 201 and 202 in between them can serve as repeater stations. As shown in FIG. 2, short-range optical wireless links 211 and 212 are used to extend the length of short-range optical link 210. In accordance with the invention, buildings 201 and 202 can have their own high-speed data access even though they are serving as repeater stations. As described below, repeaters according to the invention are capable of adding and/or dropping data.

Building 201 is shown sharing its data accesses with neighboring buildings 204, 205, and 206 via short-range optical wireless links 213. Building 201 is coupled to building 204 by a short-range optical wireless link 213A. Building 201 is coupled to building 205 by a short-range optical wireless link 213B. Building 201 is also coupled to building 206 by a short-range optical wireless link 213C. An optional short-range optical wireless link 213D couples buildings 205 and 206 in order to provide a more robust network.

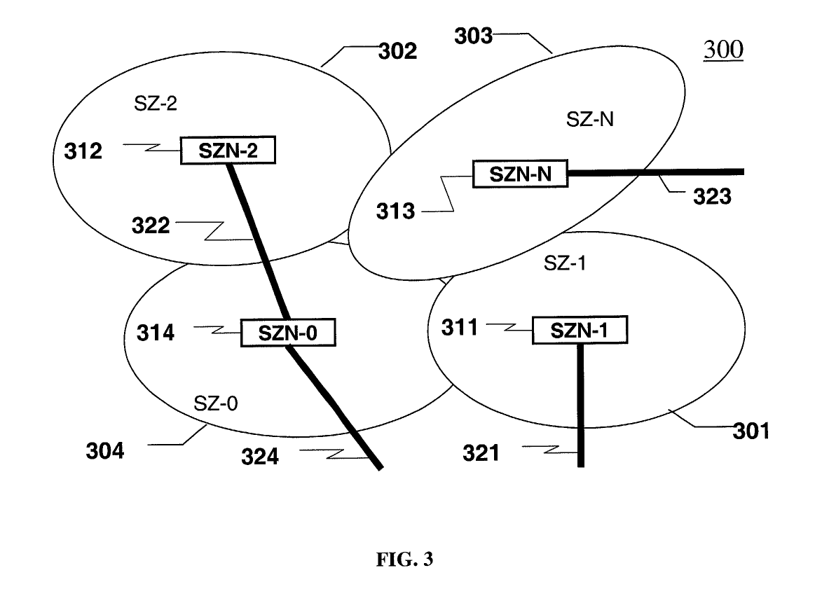

FIG. 3 illustrates a subscriber region 300 according to an embodiment of the present invention. Subscriber region 300 is partitioned into several SZs 301, 302, 303 and 304. These SZs have corresponding SZNs 311, 312, 313 and 314, respectively. SZNs 301, 302, 303 and 304 have corresponding backbone links 321, 322, 323 and 324 through which high-speed access to a major backbone or information highways (not shown) is available. A backbone link may be a preexisting or newly installed fiber-optic link, an optical wireless link, or any other high-speed link. As shown in FIG. 3, the sizes and shapes of SZs are arbitrary and may be determined by various environmental and networking parameters such as climate, geographical conditions, number of subscribers in the region, locations of available backbones, data speed required by the subscribers, et cetera. For example, depending on the data speed requested by the subscribers in a SZ, a backbone line can carry one or more dedicated OC-12 channels.

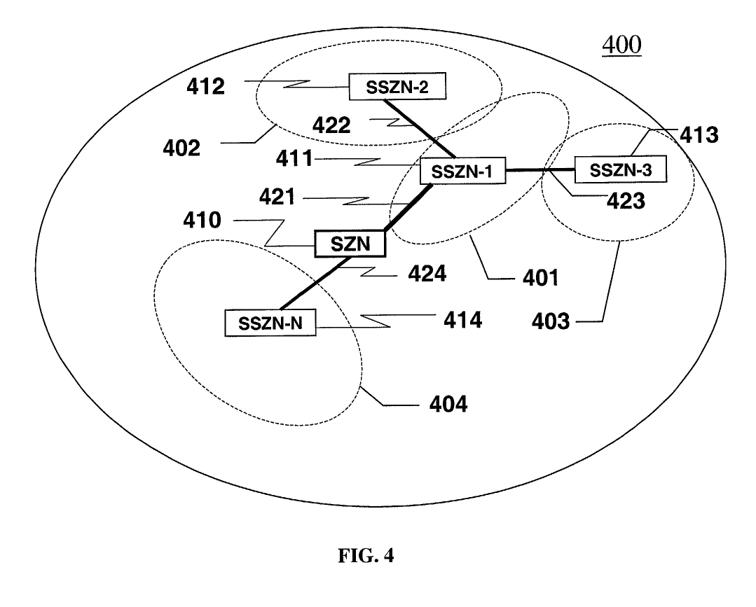

FIG. 4 illustrates a SZ 400 with SSZs 401, 402, 403, and 404 according to the invention. SZ 400 has a SZN 410. SSZs 401, 402, 403, and 404 each have a corresponding SSZN 411, 412, 413, and 414, respectively. SSZNs 411, 412, 413, and 414 each have a corresponding extended backbone link 421, 422, 423, and 424. Extended backbone links 421, 422, 423, and 424 have high-speed access to SZN 410. In an embodiment, extended backbones links 421, 422, 423, and 424 comprise short-range and/or medium-range optical wireless links according to the invention. In embodiments, other high-speed wired and/or wireless links are used.

Subscribers in a SSZ share the data service from a SSZN. In an embodiment, for example in an urban residential area, 10 to 20 subscribers comprising a SSZ can share 155 megabits per second SONET data access or 100 megabits per second Ethernet data access. The size and shape of a SSZ is selected, for example, based on the number of subscribers, environmental parameters, and the speed and/or size of the data service required by subscribers.

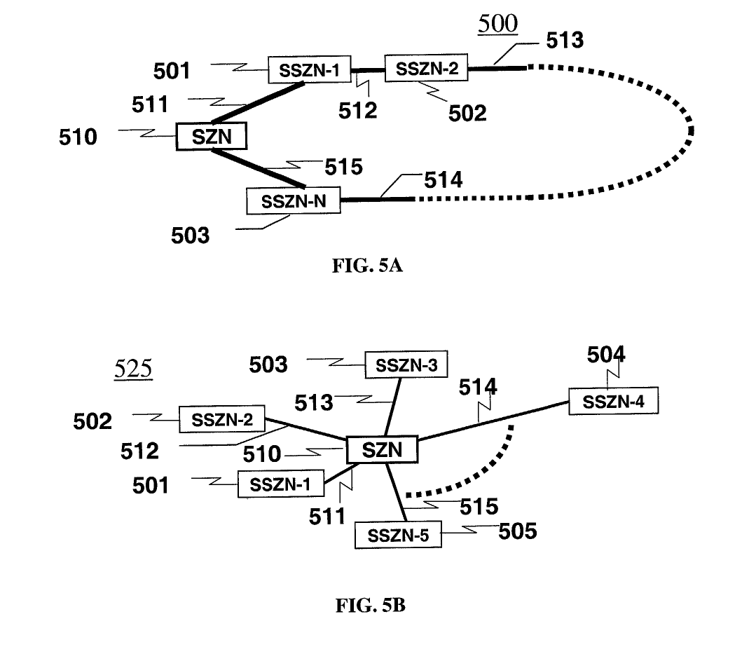

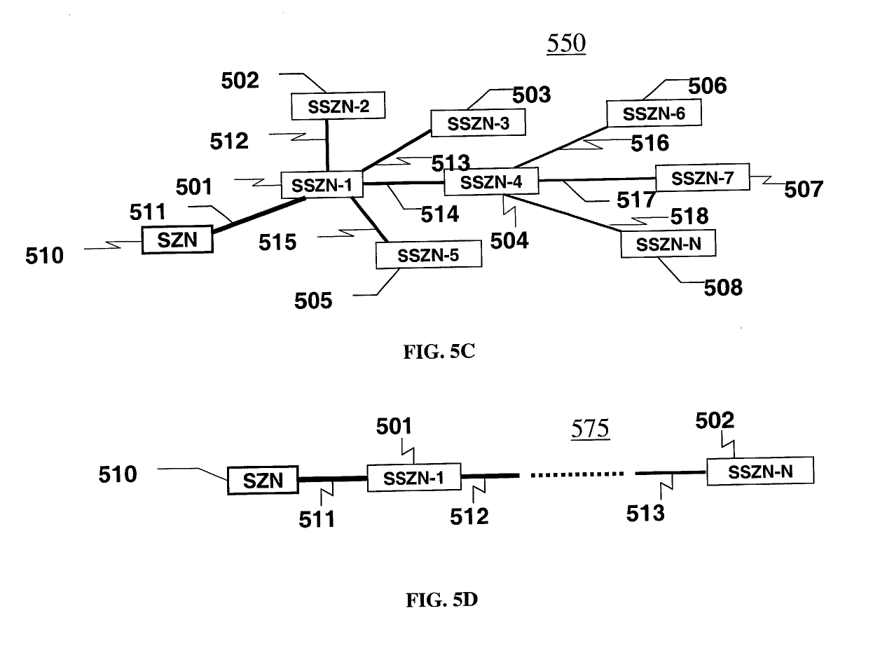

FIG. 5A illustrates a subscriber network 500 comprising a SZN 510 and SSZSs 501, 502, and 503. Subscriber network 500 has a ring topology. In an embodiment, short-range optical wireless links 511, 512, 513, 514, and 515 according to the invention are used for networking the SSZNs of network 500. In other embodiments, one or more conventional high-speed wired and/or wireless links can be used.

FIG. 5B illustrates a subscriber network 525 comprising a SZN 510 and SSZNs 501, 502, 503, 504 and 505. Subscriber network 525 has a star topology. In an embodiment, short-range optical wireless links 511, 512, 513, 514, and 515 according to the invention are used for networking the SSZNs of network 525. In other embodiments, one or more conventional high-speed wired and/or wireless links can be used.

FIG. 5C illustrates a subscriber network 550 comprising a SZN 510 and SSZNs 501, 502, 503, 504, 505, 506, 507 and 508. Subscriber network 550 has a tree topology. In an embodiment, short-range optical wireless links 511, 512, 513, 514, 515, 516, 517 and 518 according to the invention are used for networking the SSZNs of network 550. In other embodiments, one or more conventional high-speed wired and/or wireless links can be used.

FIG. 5D illustrates a subscriber network 575 comprising a SZN 510 and SSZSs 501 and 502. Subscriber network 575 has a bus topology. In an embodiment, short-range optical wireless links 511, 512, and 513 according to the invention are used for networking the SSZNs of network 575. In other embodiments, one or more conventional high-speed wired and/or wireless links can be used.

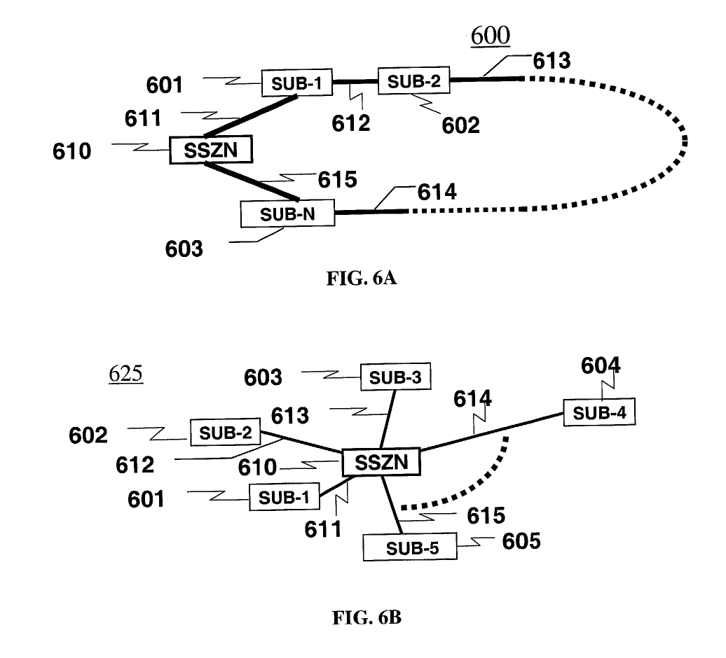

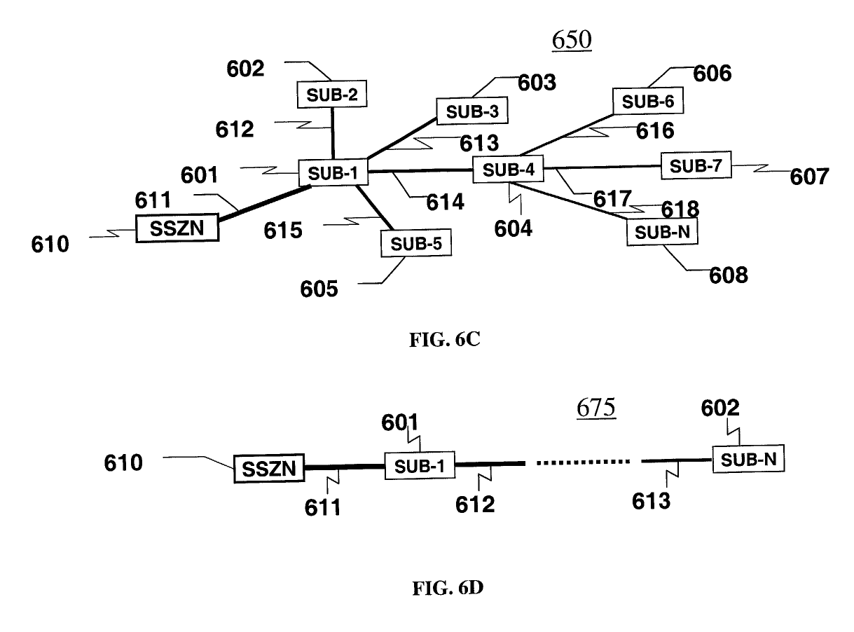

FIG. 6A illustrates a subscriber network 600 comprising a SSZN 610 and subscribers 601, 602, and 603. Subscriber network 600 has a ring topology. In an embodiment, short-range optical wireless links 611, 612, 613, 614, and 615 according to the invention are used for networking the subscribers of network 600. In other embodiments, one or more conventional high-speed wired and/or wireless links can be used.

FIG. 6B illustrates a subscriber network 625 comprising a SSZN 610 and subscribers 601, 602, 603, 604 and 605. Subscriber network 625 has a star topology. In an embodiment, short-range optical wireless links 611, 612, 613, 614, and 615 according to the invention are used for networking the subscribers of network 625. In other embodiments, one or more conventional high-speed wired and/or wireless links can be used.

FIG. 6C illustrates a subscriber network 650 comprising a SSZN 610 and SSZNs 601, 602, 603, 604, 605, 606, 607 and 608. Subscriber network 650 has a tree topology. In an embodiment, short-range optical wireless links 611, 612, 613, 614, 615, 616, 617 and 618 according to the invention are used for networking the subscribers of network 650. In other embodiments, one or more conventional high-speed wired and/or wireless links can be used.

FIG. 6D illustrates a subscriber network 675 comprising a SSZN 610 and subscribers 601 and 602. Subscriber network 675 has a bus topology. In an embodiment, short-range optical wireless links 611, 612, and 613 according to the invention are used for networking the subscribers of network 675. In other embodiments, one or more conventional high-speed wired and/or wireless links can be used.

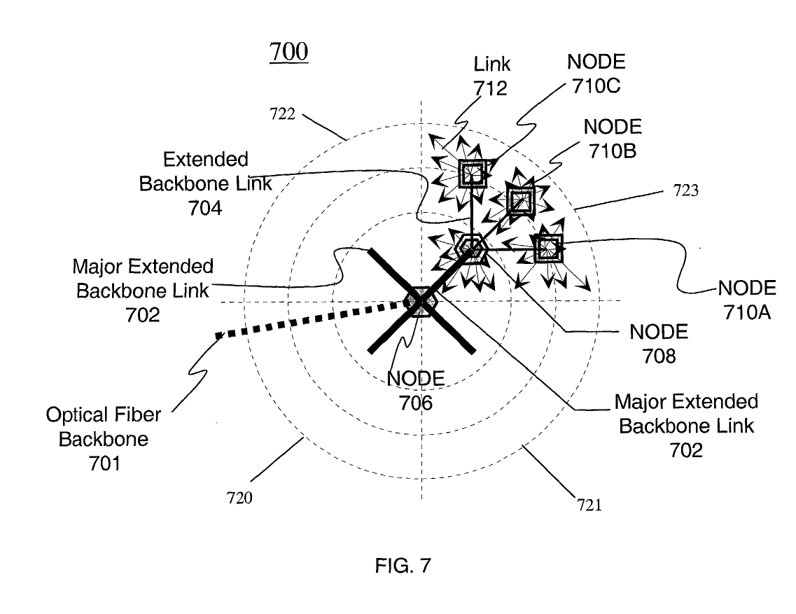

FIG. 7 illustrates a subscriber network 700 according to an embodiment of the invention. Subscriber network 700 comprises four zones 720, 721, 722, and 723. Zone 723 comprises three nodes 708, 710A, 710B, and 710C. Node 708 is a repeater node that has access service to an optical fiber backbone 701 at a node 706. Node 708 is coupled to node 706 by a major extended backbone link 702. Each of the nodes 710 is coupled to node 708 by an extended backbone link 704. Each node 708, 710A, 710B, and 710C comprises a plurality of short-range optical wireless links 712 according to the invention.

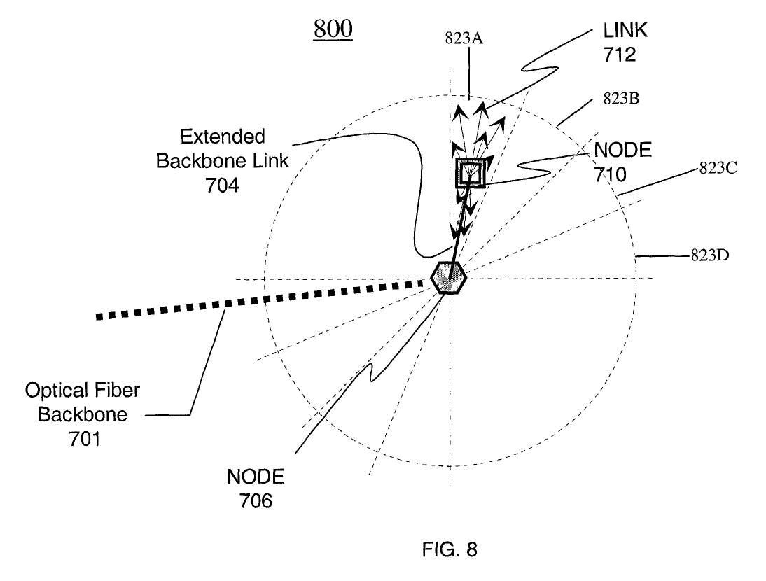

FIG. 8 illustrates a subscriber network 800 according to an embodiment of the invention. Subscriber network 800 is similar to subscriber network 700. In network 800, zone 723 has been subdivided into four zones 823A, 823B, 823C, and 823D. Each zone 823A, 823B, 823C, and 823D has a node 710 coupled to a node 706 by an extended backbone link 704. Furthermore, each node 710 comprises a plurality of short-range optical wireless links 712 according to the invention. Subscriber network 800 illustrates an alternative means for providing subscriber service according to the invention to zone 723 in FIG. 7, as will be understood by a person skilled in the relevant art given the description of the invention herein.

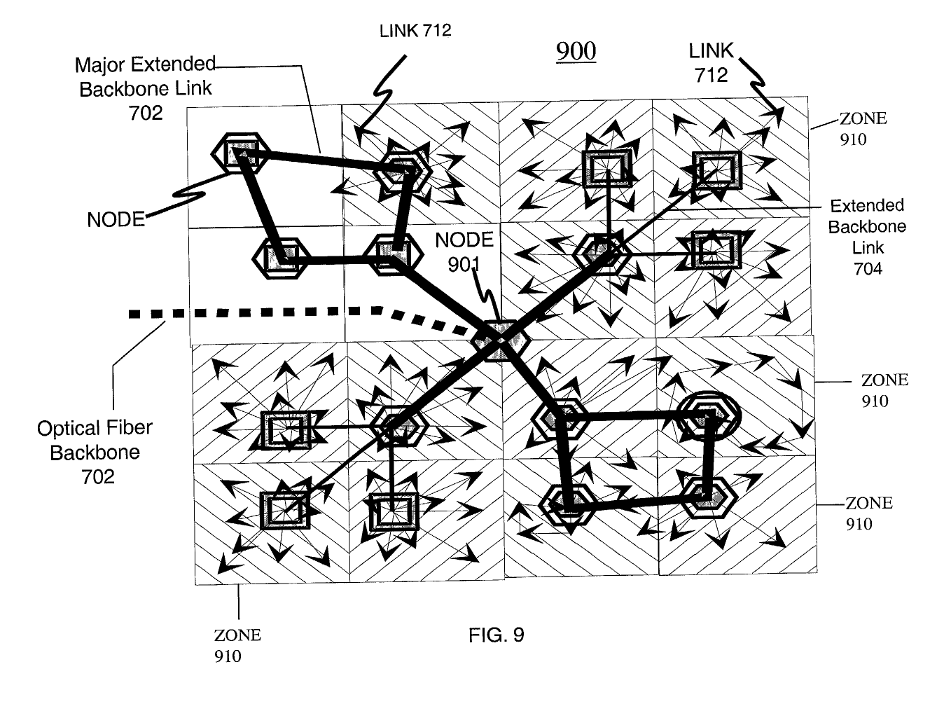

FIG. 9 illustrates a subscriber network 900 according to an embodiment of the invention. Subscriber network 900 comprises a plurality of nodes including a node 901. Node 901 has access to an optical fiber backbone 701. The nodes of subscriber network 900 are coupled together using major extended backbone links 702 and extended backbone links 704. Each node is coupled to a plurality of short-range optical wireless links 712. As shown in FIG. 9, subscriber network 900 provides subscriber service to sixteen zones 910. A person skilled in the relevant art will understand how to implement subscriber network 900 given the description of the invention herein.

As will be understood by a person skilled in the relevant art given the description herein, short-range optical wireless links 712 can also be used to serve as a backbone. Thus, in some or all subscriber regions of zones of a city, short-range optical wireless links 712 can be used in place of major extended backbone links 702 and extended backbone links 704. For example, in FIG. 7, nodes 710A-C can be coupled to node 708 by short-range optical wireless links 712 rather than extended backbone links 704. Furthermore, node 708 can be coupled to node 706 by one or more short-range optical wireless links 712 rather than a major extended backbone link 702. In embodiments of the invention, all the links shown in FIGS. 7, 8, and 9, are short-range optical wireless links 712.

As can see in FIGS. 7, 8, and 9, short-range optical wireless links can cover a large geographical area. For example, if the maximum length of a short-range optical wireless links in a particular region is about 200 meters, then each node of a system according to the invention can cover an area of about 125,000 square meters. If the maximum length of a short-range optical wireless links in a particular region is about 300 meters, then each node of a system according to the invention can cover an area of about 280,000 square meters. In embodiments of the invention, short-range optical wireless links carry 155 Mb/s, 622 Mb/s, 1.25 Gb/s, and/or 2.5 Gb/s data streams. Other data streams are also possible, however, as will be understood by a person skilled in the relevant art given the description herein.

### Example Device Embodiments of the Invention

In this subsection, exemplary devices according to the invention are described. These devices can be used, for example, to implement the subscriber network illustrated in FIGS. 1-9. Basic building block devices according to the invention include receivers, transmitters, transceivers, and repeaters and/or relays.

As described herein, it is a feature of the invention that for devices operating in a range of less than 25 meters, a high power light emitting diode (LED) or a vertical cavity surface-emitting laser (VCSEL) can be used as a light source for a transmitter. In addition, an off-the-shelf laser diode (LD) driver and an optical receiver chip can be used to provide low cost networking devices. A low cost, small aperture size, molded plastic lens can be used as both a collimating and a collecting optical device in a transmitter and a receiver, respectively. Standard packaging procedure can also be used to integrate these components into small size transmitter, receiver, and/or transceiver modules for wireless optical networking according to the invention.

In other ranges, other components can be used in accordance with the invention. For example, in a range up to a few hundreds meters, a VCSEL or a LD can be used for a light source. Different receiver modules according to the invention can be used for different ranges. A 0.5 inch diameter lens provides sufficient sensitivity for optical wireless links in the range 25 meters to 50 meters. In a range of 50 meters to 100 meters and a range of 100 meters to 300 meters, however, a 1-inch and a 2-inch lens, respectively, is more suitable. A VCSEL typically emits less optical power than a LD. Thus, in order to maintain compatible receiver sensitivity, a larger aperture size collection lens is required in the receiver for a VCSEL source link than for a LD source link, assuming both links operate over an equal distance. In another embodiment the transmitter can use a VCSEL array, in which different laser elements can be activated to provide adjustments in direction of the outgoing beam(s) or to provide a multicast capability.

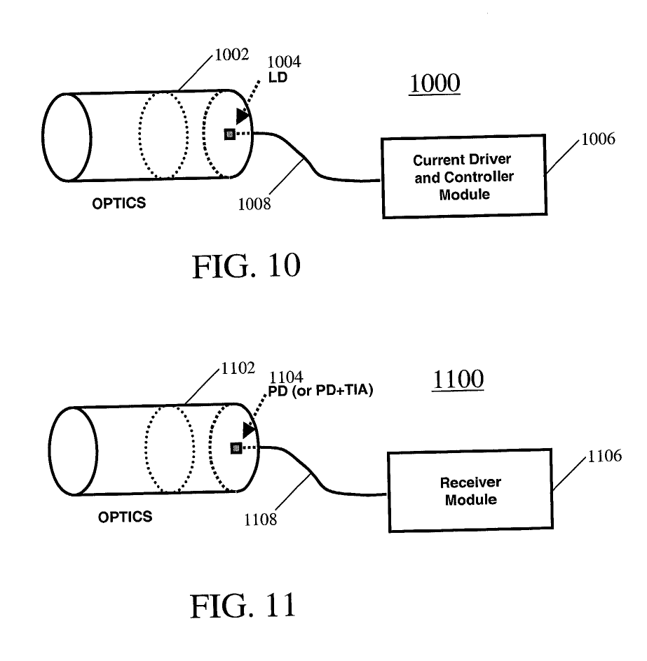

FIG. 10 illustrates a block diagram of an example transmitter 1000 according to an embodiment of the invention. Transmitter 1000 comprises an optical element 1002, a laser diode (LD) 1004, and a current driver or controller module 1006. LD 1004 is coupled to controller module 1006 by an electrical connection (EC) 1008. Optical element 1002 can comprise, for example, an aspheric lens, a Fresnel lens, a graded index lens, et cetera. LD 1004 can comprise, for example, a Fabry-Perot LD, a DFB-LD, a VCSEL, et cetera. EC 1008 can comprise any known electrical connection means such as, for example, a wire or a cable. In an embodiment, transmitter 1000 is a compact unit requiring only low voltage (e.g., 3V, 5V, 9V, et cetera) power.

In embodiments of the invention, transmitter 1000 can be built using standard optical components including but not limited to lenses, mirrors, windows, and/or LDs as would be apparent to a person skilled in the relevant art given the description herein. In embodiments, transmitter 1000 has either a fiber optic input for fiber optic connection to a subscriber network, or an electrical connection, such as an RJ45, for electrical connection to a subscriber network.

In embodiments, transmitter 1000 has either a directly modulated laser or LED, whose output is collimated with a small refractive or reflecting optical device. A beam of transmitter 1000 can be form, for example, using an LD with a fiber pigtail, whose cleaved end is positioned close to the focus of the output optical element 1002 so as to provide an almost collimated output beam. The degree of collimation of the output beam of transmitter 1000 can be adjusted to provide a desired beam footprint size at a receiver.

In an embodiment, transmitter 1000 comprises a VCSEL array, in which different laser elements are activated in order to provide adjustments in a direction of an outgoing beam or in order to provide a multicast capability.

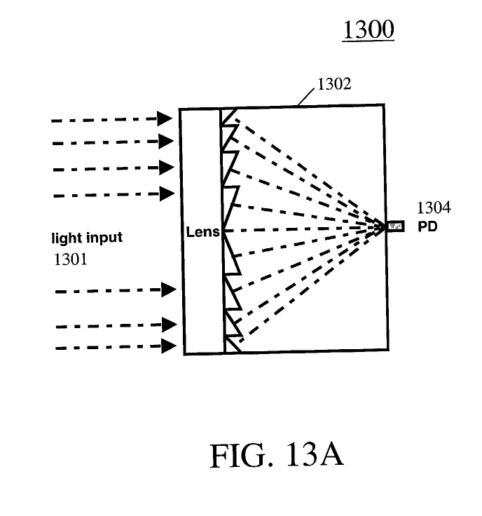

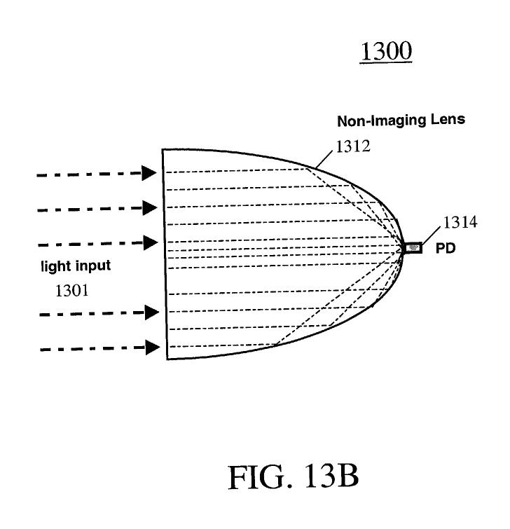

FIG. 11 illustrates a block diagram of an example receiver 1100 according to an embodiment of the invention. As shown in FIG. 11, receiver 1100 comprises an optical element 1102, a photodetector (PD) 1104, and a receiver module 1106. PD 1104 is coupled to receiver module 1106 by an EC 1108. Optical element 1102 can comprise, for example, an aspheric lens, a Fresnel lens, or a non-imaging optical device as illustrated in FIG. 13B. PD 1104 can comprise, for example, a MSM, a PIN, and APD, et cetera. EC 1108 can comprise any known electrical connection means such as, for example, a wire or a cable.

In an embodiment, receiver 1100 has an entrance window made of a material that transmits light from a transmitter, but which can be made opaque to most background light. This can be accomplished, for example, by making the entrance window from silicon, which transmits 1.3 micrometer or 1.55 micrometer laser light, but which blocks most of the energy in sunlight. Alternatively, the front window of receiver 1100 can comprise a narrowband filter at a laser wavelength coming from a transmitter.

In an embodiment, the entrance window receiver 1100 may be equipped with a protective shroud and/or a window heater to allow for outdoor operation. When used outdoors, the whole unit comprising receiver 1100 may be hermetically sealed to prevent the entrance of moisture.

In an embodiment, inside the entrance window of receiver 1100, there is a lens or lenses, and/or a non-imaging optical element to collect the received light and direct it to a sensitive surface of PD 1104. PD 1104 comprises, for example, a pin PD, an avalanche PD, or a photomultiplier tube. An electrical signal from PD 1104 is optionally amplified using an electronic amplifier/pulse shaping circuit, which may comprise a transimpedance amplifier (TIA), or other circuit elements as would be apparent to a person skilled in the relevant art given the description herein.

In embodiments of the invention, receiver 1100 can be built from off-the-shelf optical components including but not limited to lenses, mirrors, windows, PDs, avalanche photodiodes, and photomultiplier tubes as would be apparent to a person skilled in the relevant art given the description herein.

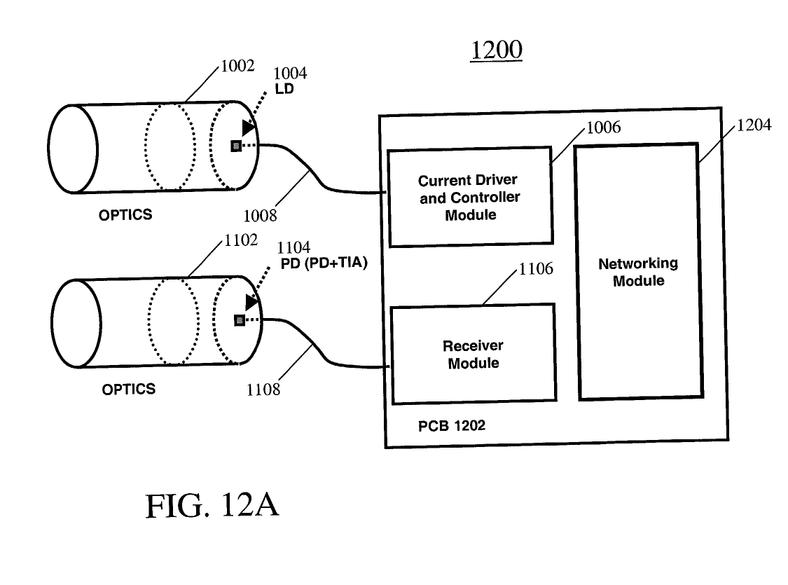

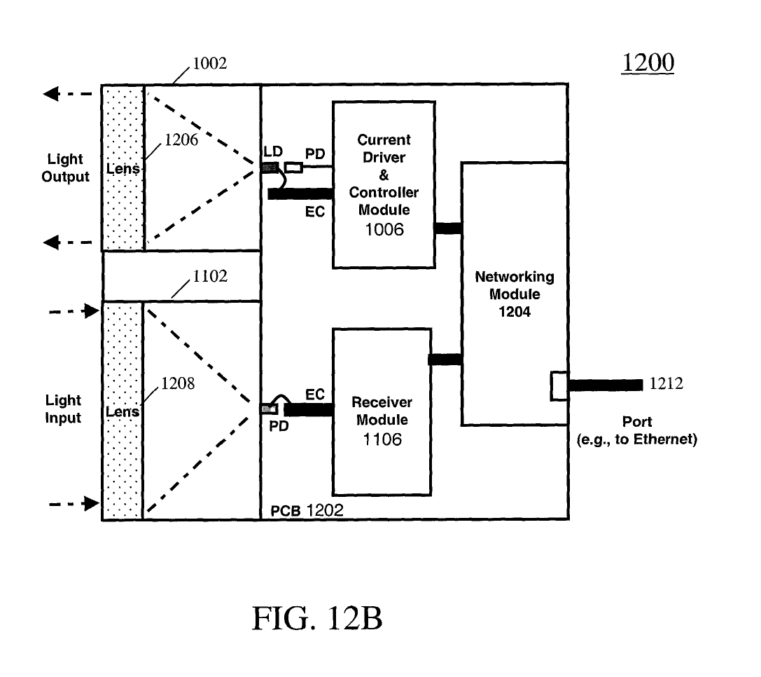

FIGS. 12A and 12B illustrate block diagrams of an example transceiver 1200 according to an embodiment of the invention. As shown in FIG. 12A, transceiver 1200 comprises a receiver portion and a transmitter portion coupled to a networking module 1204. The transmitter portion comprises an optical element 1002, a LD 1004, and a current driver and controller module 1006. LD 1004 is coupled to controller module 1006 by an EC 1008. The receiver portion comprises an optical element 1102, a PD 1104, and a receiver module 1106. PD 1104 is coupled to receiver module 1106 by an EC 1108. Controller module 1006, receiver module 1106, and networking module 1204 are coupled to and/or form a part of a printed circuit board (PCB) 1202.

FIG. 12B is a more detailed block diagram of transceiver 1200. FIG. 12B is an example of a bistatic transceiver unit. A bistatic transceiver unit is a unit wherein the transmitter and receiver sit side-by-side. For example, a bistatic optical transceiver unit can be installed in a window of the subscriber's home or apartment. A bistatic optical transceiver unit can be used to implement, for example, the tree and star network topologies described herein.

As shown in FIG. 12B, optical element 1002 comprises a lens 1206, and optical element 1102 comprises a lens 1208. Networking module 1204 is coupled to a port 1212. Port 1212 can be, for example, an Ethernet port. Alternatively, networking module 1204 can be coupled to a switch or a hub.

FIGS. 13A and 13B illustrate exemplary optical devices used with embodiments of the invention. FIG. 13A illustrates a Fresnel lens 1302 used, for example, to collect received light and direct it to a sensitive surface of PD 1304. FIG. 13B illustrates a non-imaging optical device 1312 used, for example, to collect received light and direct it to a sensitive surface of PD 1314. As described herein, optical devices 1302 and 1312 can also be used in embodiments of the invention to collimate a transmitter beam.

It is noted that the optical wireless links according to the invention are intended to operate over a variety of distances. For example, a short-range optical wireless link according to the invention is intended to operate over a distance up to 300 meters. This distance, however, can be divided into several sub-ranges and networking devices such as transmitters, receivers, transceivers, et cetera optimally designed to operate over these corresponding sub-ranges. In an embodiment, sub-ranges can be set, for example, as less than 25 meters, 25 to 50 meters, 50 meters to 100 meters, and so forth.

As will be understood by a person skilled in the relevant art, manufacturing costs are typically proportional to an operating range of a device. For example, the manufacturing costs for communication devices such as transmitters, receivers, and/or transceivers according to the invention designed to operator in a range of 0-25 meters will generally be lower than the costs for similar devices designed to operate in a range of 100-200 meters. Thus, it may be desirable to build and use devices according to the invention that are intended to be used in a particular range or sub-range. By building and using such devices, the overall costs for implementing a customizable subscriber network according to the invention can be reduced.

As described herein, a customizable subscriber network according to the invention can be implemented using short-range optical wireless links. These links provide subscribers in a subscriber region with customizable, high-speed data access. A subscriber region may be divided into one or more subscriber zones. In an embodiment of the invention, all subscribers in a subscriber region are networked using only short-range optical wireless links according to the invention. In other embodiment, medium-range and/or long-range optical wireless links, optical fiber links, and/or other high-speed wired or wireless communication links can be used, in addition to short-range optical wireless links according, to network subscribers in a subscriber region.

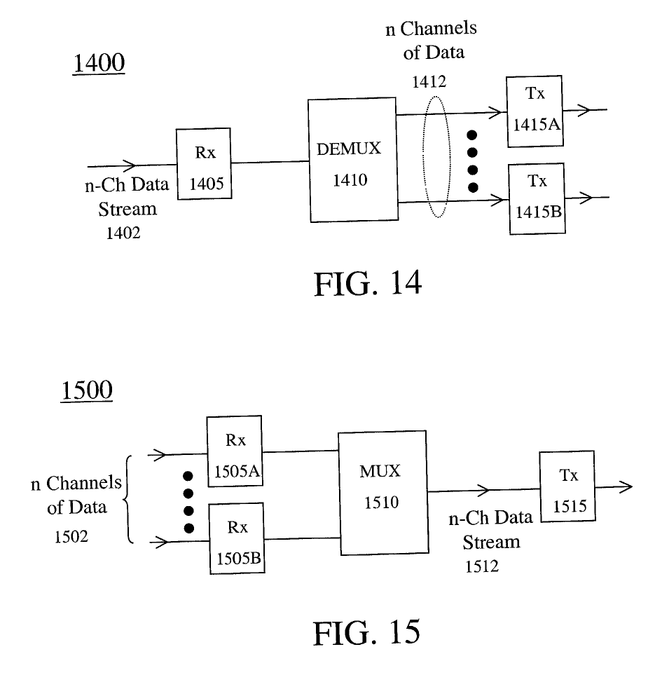

FIGS. 14-19 illustrate networking modules or units that can be used to implement the subscriber network topological structures described above.

FIG. 14 illustrates a demultiplexing module or unit 1400. An optical n-channel data stream 1402 (e.g., 4×622 megabits per second) is received by a receiver 1405 which is interfaced to a demultiplexer 1410. Demultiplexed n-channels of data 1412 (e.g., 4 channels of 622 megabits per second) are interfaced to corresponding transmitters (e.g., transmitters 1415A and 1415B). Either optical fiber or optical wireless links can be used to transport the n-channel data stream 1402 to receiver 1405. Demultiplexed channels of data 1412 are transmitted to corresponding receivers using optical wireless links, optical fiber links, and/or electrical data transmission lines.

FIG. 15 illustrates a multiplexing unit 1500. N-channels of data 1502 (e.g. 4 channels of 155 megabits per second) transmitted using, for example, either optical wireless links, optical fiber links, or electrical data transmission lines, are received by corresponding receivers (e.g., receivers 1505A and 1505B). These receivers are interfaced using a multiplexer 1510. Multiplexed n-channel data stream 1512 (e.g., 4×155 megabits per second) drives a transmitter 1515. Multiplexed n-channel data stream 1512 can be transmitted to another network using, for example, an optical wireless link or optical fiber link.

Multiplexing unit 1500 can be used, for example, in a SZN. N-channels of optical data 1502 from SSZNs can be received using, for example, receivers 1505A and 1505B and multiplexed by 1510. The multiplexed signal is then sent to a backbone using transmitter 1515.

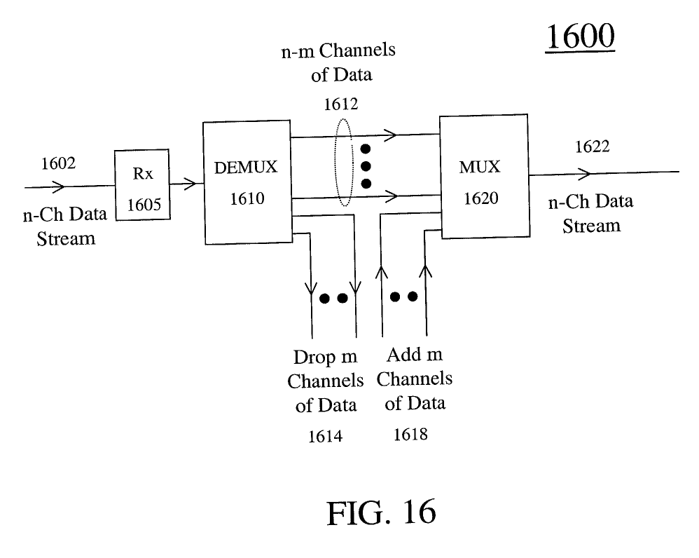

FIG. 16 illustrates an add/drop-multiplexing unit 1600. Incoming n-channel data stream 1602 is received by a receiver 1605. Receiver 1605 is interfaced to n-channel demultiplexer 1610. M-channels of data 1614 (from n-channel data stream 1602) are dropped, for example, to a subscriber, subscribers, or another network via an electrical data transmission line or lines, an optical wireless link or links, and/or an optical fiber link or links. The remaining n-m channels of data 1612 (from n-channel data stream 1602) are directly coupled to a multiplexer 1620, where these channels and m-channels of data 1618 from the corresponding subscriber or subscribers are multiplexed by multiplexer 1620. Multiplexed n-channel data stream 1622 from multiplexer 1620 is sent, for example, to other subscriber zone node or backbone. Incoming and outgoing n-channel data streams 1602 and 1622, respectively, are carried, for example, by optical wireless links or optical fiber links.

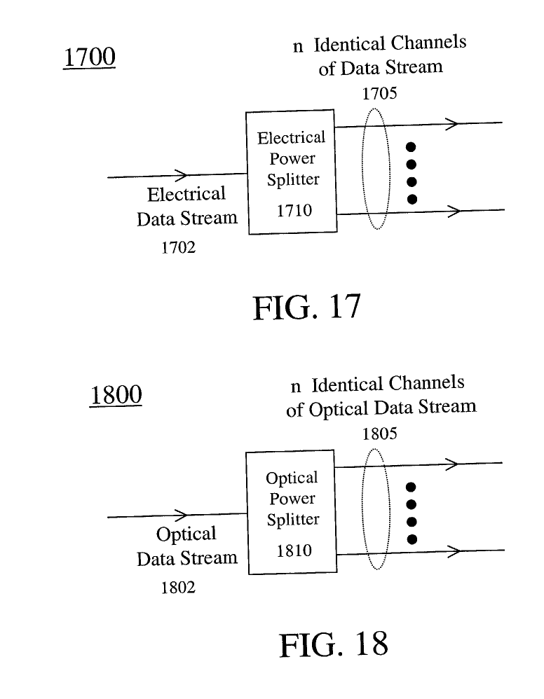

FIG. 17 illustrates a 1×n coupler unit 1700 using a wideband electrical power splitter. Incoming electrical data stream 1702 is coupled into n identical channels of data stream 1705 using a wideband electrical power splitter 1710. These n channels of data are coupled to a transmitter through which subscribers can share the incoming data stream 1702. Coupler unit 1700 can be used for down stream links, for example, for a star network topology.

FIG. 18 illustrates a 1×n coupler unit 1800 using an optical power splitter. A high power optical beam 1802 carrying wideband data can be split into n identical channels of optical data stream 1805 by the use of an optical power splitter 1810. Optical power splitter 1810 can comprise, for example, a set of properly aligned optical beam splitters, an 1×n optical fiber coupler, diffractive optics, et cetera. Each beam is directed to a corresponding subscriber.

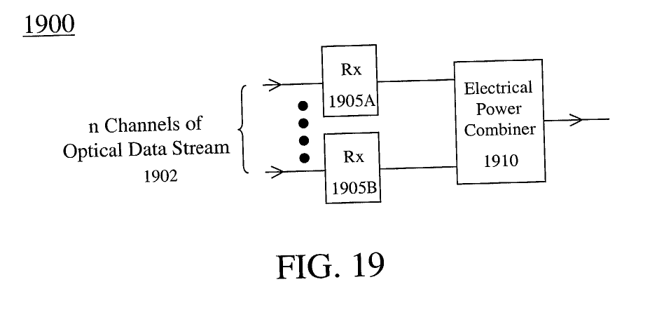

FIG. 19 illustrates an n×1 combiner unit 1900. N-channels of optical data stream 1902 is converted to corresponding electrical signals by corresponding receivers (e.g., receivers 1905A and 1905B). These electrical signals are combined at a wideband electrical power combiner 1910. The same algorithm used for configuring upstream data links in an ATM passive optical network system can be used for combiner unit 1900.

Before describing example method embodiments of the invention, it is noted here that manufacturing costs for transmitters, receivers, and transceivers according to the invention are typically exponentially proportional to operating range. This result is due to several features of the invention.

Firstly, low power LDs can be used as the light source for transmitter embodiments of the invention. A low power LD is cheaper than a high power LD. In addition, the driving electronics for a low power LD cost less than the driving electronics for a high power LD.

Secondly, since a low power LD having a suitable symmetric output beam profile is commercially available, and the beam can propagate over short distances, a short-range transmitter according to the invention does not require sophisticated and expensive collimating optics. For example, a Fabry-Perot LD is commercially available from Mitsubishi Electric Corporation (Mitsubishi ML725B8F) that has 25 degree and 30 degree beam divergence angles, for parallel and perpendicular directions to the LD plane, respectively. The output beam from this LD can be easily collimated using a low cost lens. The maximum output power of this laser is typically 10 milliwatts. Thus, it can be used as a light source for a short-range transmitter according to the invention. Although the output power is lower than that for a Fabry-Perot LD, the spatial profile of the output beam from a VCSEL is symmetric. Since a VCSEL is cheaper than a Fabry-Perot LD, it can be used for a shorter range (e.g., less than 100 m), lower cost optical wireless transmitter according to the invention.

Thirdly, since the beam size at a receiver according to the invention is relatively small, and since signal fading due to atmospheric turbulence is negligible, a low cost small aperture size lens can be used as the collecting optics for a short-range optical wireless receiver according to the invention.

Fourthly, since the size of components for devices according to the invention are relatively small, these components can be integrated. For example, a collimating or receiving lens can be mounted in a metal housing using a standard lens mounting technique, and a TO can packaged LD or PD can be welded to the metal housing. For a shorter-range transmitter, a small size collimating lens can be directly mounted on the TO can.

Lastly, since the communication devices according to the invention are very small and light-weight, they can be mounted on a small, robust, low cost mounting jig.

### Example Method Embodiments of the Invention

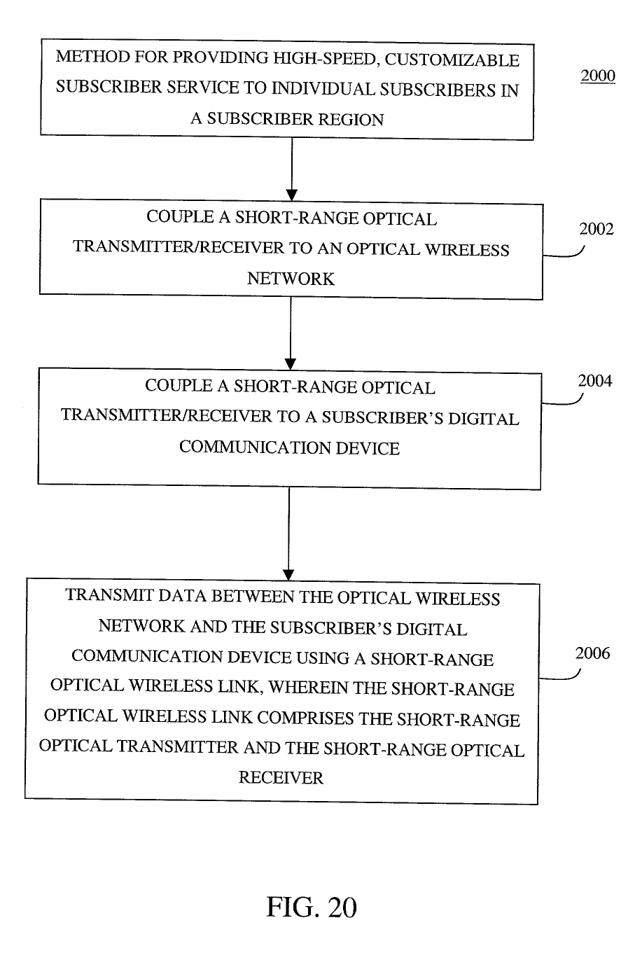

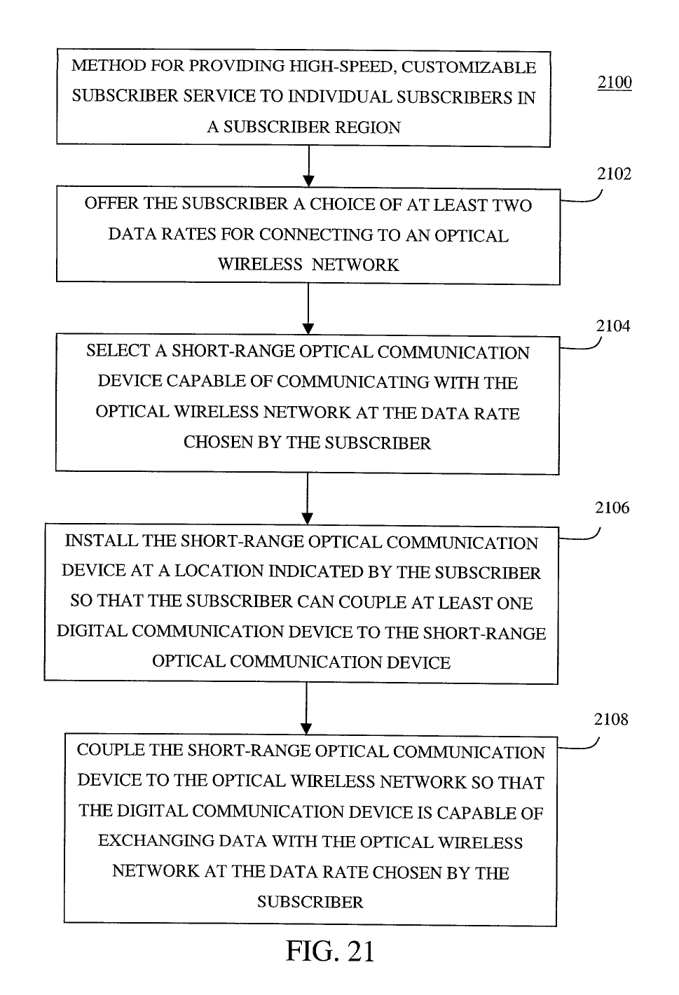

FIG. 20 illustrates a flowchart of a method 2000 for providing customizable subscriber access to an optical wireless network according to an embodiment of the invention. Method 2000 comprises steps 2002, 2004, and 2006. Method 2000 is described with regards to the features of the invention discussed above.

In step 2002, a short-range optical transmitter/receiver is coupled to a node of an optical wireless network according to the invention. In one embodiment, transmitter 1000 of FIG. 10 is coupled to an Ethernet port of a local area network of an office building (node) in order to transmit data to a subscriber. In other embodiments, other transmitters according to the invention are used. For example, in another embodiment, the transmitter/receiver of transceiver 1200 is coupled to an Ethernet port of a local area network. Transceiver 1200 can be used to both transmit data to a subscriber and receive data from the subscriber. In other embodiments, a short-range optical transmitter/receiver according to the invention is coupled to a hub or a switch rather than an Ethernet port.

The short-range optical transmitter of method 2000 forms a beam of electromagnetic energy that is eye-safe. For example, in one embodiment, the beam of electromagnetic energy has a width of at least 2 centimeters at a distance of 10 meters from the transmitter. In an embodiment, the short-range optical transmitter forms a collimated beam of electromagnetic energy having a minimum nominal beam divergence of 1×10⁻³ radian. In one embodiment, the beam of electromagnetic energy has a nominal wavelength of 1.55×10⁻⁶ meters. Other wavelengths can be used, however, in accordance with method 2000.

In step 2004, a short-range optical transmitter/receiver is coupled to a subscriber's digital communication device. In one embodiment, the subscriber's digital communication device is a computer. In other embodiments, the subscriber's digital communication device can comprise another type of audiovisual device such as, for example, an interactive television or home entertainment system. Coupling a short-range optical receiver to a subscriber's digital communication device allows the device to receive data transmitted by a short-range optical transmitter. Coupling a short-range optical transmitter to the subscriber's digital communication device allows the device to transmitted data to a short-range optical receiver coupled to the optical wireless network. In some embodiments, the short-range optical transmitter/receiver is coupled to a local area digital communication device network of a building. This permits more than one digital communication device at a subscriber's location to be coupled to the optical wireless network.

In step 2006, data from the optical wireless network is transmitted to the subscriber's digital communication device via a short-range optical wireless link. The short-range optical wireless link of method 2000 is formed using at least one short-range optical transmitter and at least one short-range optical receiver according to the invention. In step 2006, data can also be optionally transmitted from the subscriber's digital communication device via the short-range optical wireless link to the optical wireless network, for example, when the link comprises two transceivers 1200.

Method 2000 can be used, for example, to link a computer located in a first building (e.g., a residential unit of a high-rise apartment building) to a local area computer network of an adjacent second building (e.g., a commercial office building). In an embodiment, a transmitter according to the invention is coupled to the local area computer network of the second building using an available Ethernet port. The transmitter is located in a window of the second building and aimed at a receiver according to the invention located in a window of the first building. The receiver is coupled to the computer. Data is sent to the computer from the local area computer network via the first optical link. In embodiments, the first optical wireless link also comprises a second short-range optical transmitter coupled to computer and a second short-range optical receiver coupled to the local area computer network. The second short-range optical transmitter is aimed at the second short-range optical so that data can be sent from the computer to the local area computer network. In one embodiment, the first short-range optical transmitter and the second short-range optical receiver are combined in a first short-range optical transceiver, and the second short-range optical transmitter and the first short-range optical receiver are combined in a second short-range optical transceiver.

As will be apparent to a person skilled in the relevant arts given the description herein, method 2000 can be used to implement any of the subscriber networks described above.

FIG. 21 illustrates a flowchart of a method 2100 for providing a subscriber customizable access to an optical wireless network according to an embodiment of the invention. Method 2100 comprises steps 2102, 2104, 2106 and 2108. Method 2100 is described with regards to the features of the invention discussed above.

In step 2102, the subscriber is offered a choice of at least two data rates for connecting to the optical wireless network. As described herein, short-range optical links of the invention are capable of providing a plurality of different data rates. This feature of the invention allows a provider of network services to offer the subscriber customizable access to the optical wireless network. In accordance with method 2100, the subscriber can chose a data rate for connecting to a network based on the subscriber's needs and the cost charged by the network service provider for a particular access data rate.

In step 2104, a short-range optical communication device capable of communicating with the optical wireless network at the data rate chosen by the subscriber is selected for installation at a location indicated by the subscriber. Several devices are described herein that can be used for providing the subscriber with access to the optical wireless network at a chosen data rate. For example, transceiver 1200 may be used to provide two-way communications with the optical wireless network. Transceiver 1200 can be coupled to a variety of digital communications devices such as, for example, a computer or another type of interactive audiovisual device. Other optical communication devices according to the invention can also be selected.

In step 2106, the short-range optical communication device selected in step 2104 is installed at the location indicated by the subscriber. For example, if the subscriber intends to have access to the optical wireless network from her home, she can chose to have the short-range optical communication device installed in her home or apartment. As described above, the short-range optical communication device could be installed, for example, in a window of the subscriber's home or apartment. Alternatively, the subscriber may chose to have the short-range optical communication device installed on an electrical pole near the subscriber's residence, and a wire running from the device to the subscriber's residence. This installation option would allow the service provider to have access to the short-range optical communication device without having to enter the subscriber's residence. Many other installation options are possible, as will be understood by a person skilled in the relevant art given the description herein.

In step 2108, the short-range optical communication device selected in step 2104 is coupled to the optical wireless network so that a digital communication device coupled to the short-range optical communication device is capable of exchanging data with the network at the data rate chosen by the subscriber.

Further features and advantages of method 2100 will be apparent to a person skilled in the relevant art given the detailed description of the invention herein.

### Conclusion

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A system for providing high-speed, customizable subscriber service to individual subscribers in a subscriber region, comprising:
an optical wireless network having a plurality of short-range optical wireless links,
wherein said optical wireless network has a range that covers at least one subscriber zone subdivided into at least two sub-subscriber zones,
each of said plurality of short-range optical wireless links having a short-range optical transmitter and a short-range optical receiver, and
wherein a distance between said short-range optical transmitter and said short-range optical receiver of each of said plurality of short-range optical wireless links is less than a maximum distance over which fading of received optical power caused by atmospheric turbulence can be neglected; and
at least one subscriber zone node coupled to at least one short-range optical wireless link of said optical wireless network,
said at least one subscriber zone node having access to a high-speed, major backbone.

2. The system of claim 1, wherein
said short-range optical transmitter forms a beam of electromagnetic energy that is eye-safe.

3. The system of claim 2, wherein
said beam of electromagnetic energy has a width of at least 2 centimeters at a distance of 10 meters from said transmitter.

4. The system of claim 1, wherein
a lens of said short-range optical receiver is a non-imaging optical device.

5. The system of claim 1, wherein
a lens of said short-range optical receiver is an aspheric lens.

6. The system of claim 1, wherein
a lens of said short-range optical receiver has a wide aperture.

7. The system of claim 1, wherein
a lens of said short-range optical receiver is a Fresnel lens.

8. The system of claim 1, wherein
a lens of said short-range optical receiver is a set of refracting optical elements.

9. The system of claim 1, wherein
a lens of said short-range optical receiver is a set of reflecting optical elements.

10. The system of claim 1, wherein
said short-range optical transmitter of at least one of said plurality of short-range optical wireless links is coupled to a local area digital communication device network of a building.

11. The system of claim 11, wherein
said building is a single-family residential dwelling.

12. The system of claim 11, wherein
said short-range optical transmitter is coupled to an Ethernet port.

13. The system of claim 11, wherein
said short-range optical transmitter is coupled to a switch.

14. The system of claim 11, wherein
said short-range optical transmitter is coupled to a hub.

15. The system of claim 1, wherein
at least one said short-range optical transmitter is a part of a bistatic transceiver unit.

16. The system of claim 15, wherein
at least one bistatic transceiver unit is coupled to an electrical pole.

17. The system of claim 1, wherein
at least one said short-range optical receiver is a part of a bistatic transceiver unit.

18. The system of claim 17, wherein
said bistatic transceiver unit is solar powered.

19. The system of claim 17, wherein
said bistatic transceiver unit is battery powered.

20. The system of claim 17, wherein
said bistatic transceiver unit is located inside a building and proximate to a window.

21. The system of claim 1, wherein
said short-range optical transmitter of at least one of said plurality of short-range optical wireless links is located inside a building and proximate to a window.

22. The system of claim 1, wherein
at least one of said plurality of short-range optical wireless links comprises a 2.5 gigabit transponder having sixteen 155 megabit communication channels.

23. The system of claim 1, wherein
at least one of said plurality of short-range optical wireless links comprises a 2.5 gigabit transponder having four 622 megabit communication channels.

24. The system of claim 1, wherein
said distance between said short-range optical transmitter and said short-range optical receiver of each of said plurality of short-range optical wireless links is less than 300 meters.

25. The system of claim 24, wherein
said distance between said short-range optical transmitter and said short-range optical receiver of at least one of said plurality of short-range optical wireless links is greater than 100 meters.

26. The system of claim 24, wherein
said distance between said short-range optical transmitter and said short-range optical receiver of at least one of said plurality of short-range optical wireless links is less than 50 meters.

27. The system of claim 24, wherein
said distance between said short-range optical transmitter and said short-range optical receiver of at least one of said plurality of short-range optical wireless links is less than 25 meters.

28. The system of claim 1, wherein
at least one of said sub-subscriber zones has a star topology.

29. The system of claim 1, wherein
at least one of said sub-subscriber zones has a tree topology.

30. The system of claim 1, wherein
at least one of said sub-subscriber zones has a ring topology.

31. The system of claim 1, wherein
at least one of said sub-subscriber zones has a bus topology.

32. The system of claim 1, further comprising:
at least one medium-range optical wireless link coupled to at least one of said plurality of short-range optical wireless links,
said at least one medium-range optical wireless link having a medium-range optical transmitter and a medium-range optical receiver, and
wherein a distance between said medium-range optical transmitter and said medium-range optical receiver of said at least one medium-range optical wireless link is at least equal to the maximum distance over which fading of received optical power caused by atmospheric turbulence can be neglected, and
wherein a distance between said medium-range optical transmitter and said medium-range optical receiver of said at least one medium-range optical wireless link is less than 500 meters.

33. The system of claim 1, further comprising:
at least one long-range optical wireless link coupled to at least one of said plurality of short-range optical wireless links,
said at least one long-range optical wireless link having a long-range optical transmitter and a long-range optical receiver, and
wherein a distance between said long-range optical transmitter and said long-range optical receiver of said at least one long-range optical wireless link is at least 500 meters.

34. A method for providing high-speed, customizable subscriber service to individual subscribers in a subscriber region, the method comprising the steps of:
coupling a first short-range optical transmitter to an optical wireless network,
said optical wireless network comprising a plurality of short-range optical wireless links coupled together, and
said optical wireless network having at least one subscriber zone subdivided into at least two sub-subscriber zones;
coupling a short-range optical receiver to a first subscriber's digital communication device; and
transmitting data from the optical wireless network to the first subscriber's digital communication device using the first short-range optical transmitter and the first short-range optical receiver.

35. The method of claim 34, wherein the first subscriber's digital communication device is a computer.

36. The method of claim 34, wherein the first subscriber's digital communication device comprises an audiovisual device.

37. The method of claim 34, further comprising the step of:
transmitting data to the optical wireless network from the first subscriber's digital communication device using a second short-range optical transmitter coupled to the first subscriber's digital communication device and a second short-range optical receiver coupled to the optical wireless network.

38. The method of claim 37, wherein
the first short-range optical transmitter and the second short-range optical receiver are a first bistatic transceiver unit, and
the second short-range optical transmitter and the first short-range optical receiver are a second bistatic transceiver unit.

39. The method of claim 34, wherein
at least one of said sub-subscriber zones has a star topology.

40. The method of claim 34, wherein
at least one of said sub-subscriber zones has a tree topology.

41. The method of claim 34, wherein
at least one of said sub-subscriber zones has a ring topology.

42. The method of claim 34, wherein
at least one of said sub-subscriber zones has a bus topology.

43. A method for providing high-speed, customizable subscriber service to individual subscribers in a subscriber region, the method comprising the steps of:
offering the subscriber a choice of at least two data rates for connecting to an optical wireless network,
said optical wireless network comprising a plurality of short-range optical wireless links coupled together, and
said optical wireless network having at least one subscriber zone subdivided into at least two sub-subscriber zones;
selecting a short-range optical communication device capable of communicating with the network at the data rate chosen by the subscriber;
installing the short-range optical communication device at a location indicated by the subscriber so that the subscriber can couple at least one digital communication device to the short-range optical communication device; and
coupling the short-range optical communication device to the optical wireless network so that the digital communication device is capable of exchanging data with the network at the data rate chosen by the subscriber.
